(19) United States
(12) Patent Application Publication
(10) Pub. No.: US 2008/0251138 A1
(43) Pub. Date: Oct. 16, 2008

(54) Fuel Volatilizing Control System of Fuel Tank

(76) Inventors: Aaron Wang, Lungtan (TW); Chun-Chao Huang, Lungtan (TW)

Correspondence Address: HDSL, 4331 STEVENS BATTLE LANE, FAIRFAX, VA, 22033, US

(21) Appl. No.: 11/745,107

(22) Filed: May 7, 2007

(30) Foreign Application Priority Data
Apr. 10, 2007 (TW) 096112411

(51) Int. Cl. F16K 17/196

(52) U.S. Cl. 137/493

(57) ABSTRACT

An fuel volatilizing control system for a fuel tank, includes a fuel cover engaged to a fuel entrance of the fuel tank, a closure body arranged under the fuel cover and in the fuel entrance, a filter room containing filtering materials in the closure body and a double-lane valve comprising a first valve member and a second valve member. The first valve member and the second valve member can control whether the fuel gas flows to the environment or the outside air flows to the fuel tank.

### BACKGROUND

1. Field of the Invention

The invention relates to fuel tank covers for using on fuel tanks of vehicles, and particularly to a fuel volatilizing control system coverable of adjusting fuel gas pressure in the fuel tank and filtering nocuous materials of the fuel gas.

2. Description of the Related Art

A typical fuel tank of a vehicle will produce expanded pressure after fuel liquid volatilizing fuel gas therein, and produce vacuum pressure after fuel liquid reducing. Furthermore, the fuel tank may be distorted, and even be broken by expanded pressure or vacuum pressure decreasing. Therefore, a route to the environment is arranged in the fuel tank to reduce the expanded pressure in the fuel tank by conducting fuel gas to the environment and reduce the vacuum pressure by inhaling air from the environment.

However, the fuel gas directly flowing to the environment by the route will pollute the atmospheric environment. To solve this problem, a conventional fuel tank includes a filter canister filled with hydrocarbon filters interposed in the route to avoid environment pollution by filtering deleterious matters of the fuel gas.

Us patent pub. 2006/0016346 has disclosed a technology of a fuel tank cover combined with fuel gas treating, that is, a fuel tank system includes a filter room having activated carbon and filter sieves interposed in a route communicated with the fuel tank and the environment. When the fuel gas exhausts out to the environment by passing through the route, deleterious matters can be absorbed by the filter room and expanded pressure in the fuel tank can be reduced. When fuel liquid in the fuel tank decreases, the outside air can be inhaled from the environment though the route to reduce vacuum pressure in the fuel tank. However, the fuel tank system has no pressure control design for the passage, thus the load of the filler room increases and even the environment pollution is caused by fuel gas emission.

### BRIEF SUMMARY

An object of the invention is to provide a fuel volatilizing control system coverable of adjusting the fuel gas pressure in the fuel tank and controlling the amount of the fuel gas volatilizing.

For the above purpose, the invention provides a fuel volatilizing control system for a fuel tank. The fuel volatilizing control system includes a fuel cover engaged to a fuel gas entrance of the fuel tank; a closure body arranged under the fuel cover and in the fuel entrance; a filter room containing filtering materials in the closure body, comprising a fuel gas entrance and a fuel gas exit connecting with the environment; and a double-lane valve in the closure body, comprising an inlet communicated with the filter and an outlet communicated with the fuel gas entrance, wherein a first valve member taking on the pressure of a spring and a second valve member on the first valve member are arranged between the outlet and the inlet; a first gas route communicated with the outlet and the fuel gas entrance, arranged in the closure body or in the fuel cover or between the closure body and the fuel cover; at least an air hole communicated with the environment, arranged on the closure body or in the fuel cover or between the closure body and the fuel cover; and a second gas route communicated with the said inlet and the air hole, arranged in the closure body, in the fuel cover or between the closure body and the fuel cover.

According to the invention, the first valve member and the second valve member each can control a fuel gas route respectively, so it's easy to control whether the fuel gas flow to the environment or the outside air flow to the fuel tank. The first valve member opens when the fuel gas pressure is higher than the pressure of the spring to conduct the fuel gas to the environment through the filter room and closes when the fuel gas pressure is lower than the pressure of the spring to prevent fuel gas from flowing to the environment, and the second valve member opens when the fuel gas pressure is lower than the atmospheric pressure to conduct the outside air to the fuel tank though the filter room and closes when the fuel gas pressure is higher than the atmospheric pressure to prevent the outside air from flowing to the fuel tank. Therefore the fuel gas pressure in the fuel tank and the amount of the fuel volatilizing can be adjusted. Thus the filtering coverability of fuel cover can be enhanced to avoid the fuel gas polluting the environment.

### BRIEF DESCRIPTION OF THE DRAWINGS

These and other features and advantages of the various embodiments disclosed herein will be better understood with respect to the following description and drawings, in which like numbers refer to like parts throughout.

FIG. 1 is an exploded perspective assembly view of the fuel volatilizing control system of the invention.

FIG. 2 is a sectional view of the fuel volatilizing control system taken along the dash and dot line of FIG. 1.

FIG. 3 is a sectional view of the fuel volatilizing control system taken along the dash and dot line of FIG. 1 when the fuel gas pressure increases to higher than a set pressure.

FIG. 4 is a sectional view of the fuel volatilizing control system taken along the dash and dot line of FIG. 1 when the fuel gas pressure decreases to lower than the atmospheric pressure.

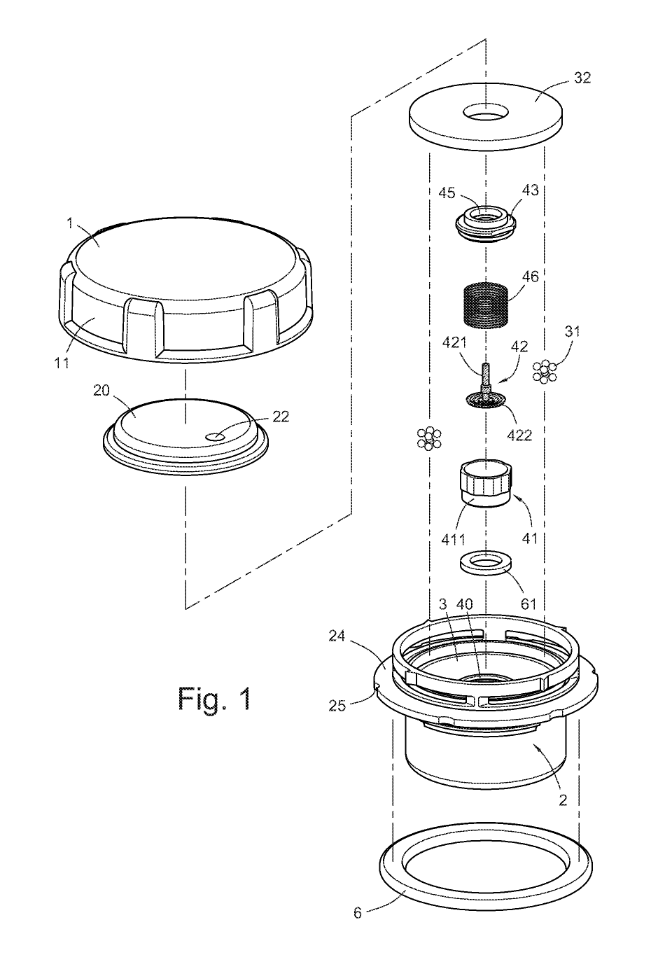

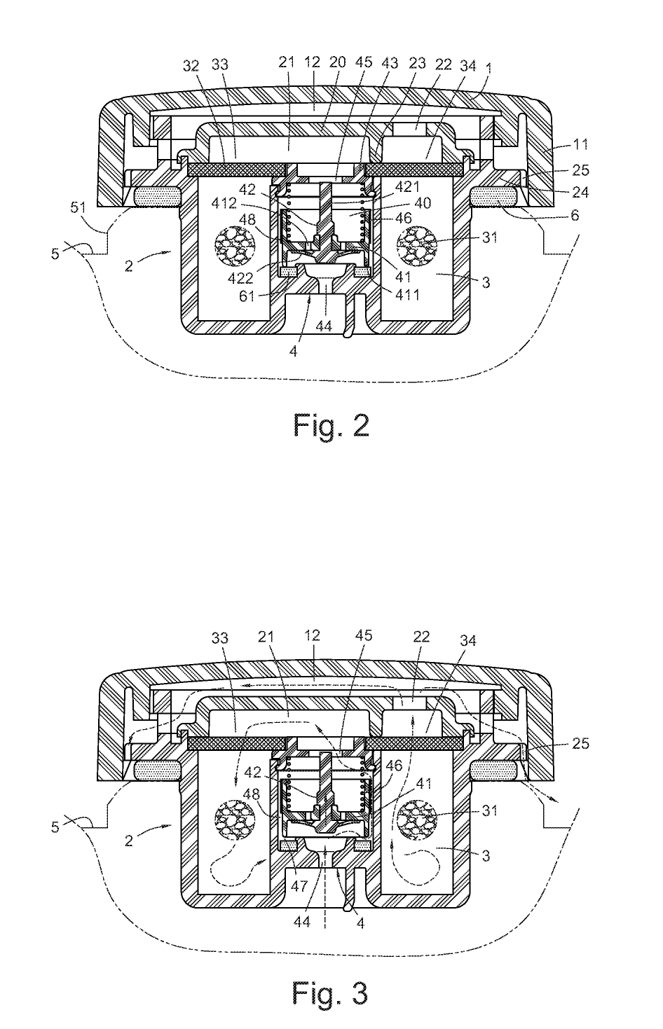

### DETAILED DESCRIPTION

The fuel volatilizing control system for a fuel tank includes a fuel cover 1, a closure body 2, a ring filter room 3, a double-lane valve 4, a first gas route 21, a gas air hole 25 and a second route 12.

The fuel cover 1 comprises an edge frame 11 mated with a fuel entrance 51 to engage the fuel cover 1 to a fuel tank 5.

The closure body 2 is arranged below the fuel cover 1 and in the fuel entrance 51. A protrusion ring 24 is formed surrounding the closure body 2 to mate with the edge frame 11. A cover board 20 comprising an air hole 22 is configured on the top of the closure body 2. A protrusion member 23 protrudes form the bottom surface of the cover board 20. A washer 6 is configured to prevent fuel gas from leaking out through the gap formed between the fuel entrance 51 and the closure body 2. A valve room 40 is provided in the closure body 2.

The ring filter room 3 is provided surrounding the valve room 40 and filled with materials such as activated carbon 31 for filtering fuel gas. A ring filter screen 32 is provided between the top of the filter room 3 and the cover board 20. The protrusion member 23 divides the space between the cover board 20 and the filter screen 32 into a fuel gas entrance 33 and a fuel gas exit 34 connected with the air hole 22.

The double-lane valve 4 is arranged in the valve room 40. A cover 43 is arranged on the valve room 40. An outlet 45 is formed in the cover 43 to connect to the valve room 40 and the fuel gas entrance 33. An inlet 44 is formed in the bottom of the closure body 2 to connect the valve room 40 and the fuel entrance 51. A first valve member 41 and a second valve member 42 arranged on the first valve member 41 are provided in the valve room 40. The first valve member 41 takes on the pressure of a spring 46.

The first gas route 21 is formed between the cover board 20 and the cover 43 to connect the outlet 44 and the fuel gas entrance 33.

The gas air hole 25 is formed between the protrusion ring 24 and edge frame 11 to connect to the environment.

The second gas route 12 is formed between fuel between the fuel cover 1 and the cover board 20 to connect the air hole 22 and the gas air hole 25.

According to a further detailed description, the first valve member includes a ring protrusion member 411 and at least an air hole 412. A washer 61 is arranged around the inlet 44 to form a ring valve 47 coverable of opening and closing the inlet 44 with ring protrusion member 411. The spring 46 is arranged between the first valve member 41 and the cover 43 to control the ring protrusion member 411 to close the valve opening 47. A fuel gas channel 48 is formed between the first valve member 41 and the sidewall of the valve room 40 to connect to the ring valve opening 47 and the outlet 45. The second valve member 42 includes an axis connected with the first valve member 41 and a plate 422 covering the air hole 2.

When the fuel gas increases in the fuel tank 5 and the gas pressure in the fuel tank is higher than the pressure of the spring 46, the first valve member 41 will open the valve opening 47, so the fuel gas can flow to the valve opening 47 through the inlet 44, and then the fuel gas will flow to the filter room 3 through the fuel gas channel 48, the outlet 44, the first gas route 21 and the fuel gas entrance 33. After being filtered by the filter room 3, the fuel gas will flow to the environment through the fuel gas exit 34, the air hole 22, the second gas route 12 and the gas air hole 25. Therefore, the gas pressure in the fuel tank 5 decreases gradually until that the gas pressure in the fuel tank 5 decreases to lower than the pressure of the spring 46 and the spring closes the valve opening 47 to prevent the fuel gas form leaking to the environment through the filter room 3.

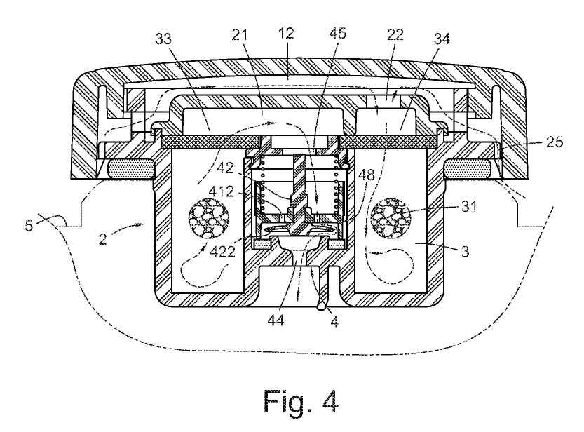

When the fuel gas pressure in the fuel tank 5 is lower than atmospheric pressure, the plate 422 will be pushed by atmospheric pressure to open the air hole 412 (shown in FIG. 4), so that the outside air can flow to the fuel tank 5 through the gas air hole 25, the second gas route 12, the air hole 22, the fuel gas exit 34, the filter room 3, the fuel gas entrance 33, the first gas route 21, the outlet 44, the air hole 412 and the inlet 44. When the fuel gas pressure in the fuel tank 5 is higher than atmospheric pressure, the plate 422 will be pushed by the fuel gas pressure to close the air hole 412 for preventing the outside air form flowing to the fuel tank 5. According to the above description, the first valve member 41 and the second valve member 42 each can control a fuel gas route respectively, so it's easy to control whether the fuel gas flow to the environment or the outside air flow to the fuel tank 5. Therefore the fuel gas pressure in the fuel tank 5 and the amount of the fuel gas fuel volatilizing can be adjusted. Thus the filtering coverability of fuel cover 1 can be enhanced.

The above description is given by way of example, and not limitation. Given the above disclosure body, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An fuel volatilizing control system for a fuel tank, comprising:
a fuel cover engaged to a fuel gas entrance of the fuel tank;
a closure body arranged on the bottom of the fuel cover and in the fuel entrance;
a filter room containing filtering materials in the closure body, comprising a fuel gas entrance and a fuel gas exit connecting with the environment; and
a double-lane valve in the closure body, comprising a an inlet communicated with the filter, an outlet communicated with the fuel gas entrance, a first valve and a second valve arranged between the fuel gas entrance and the fuel gas exit, the second valve withstanding a spring and arranged on the first valve,
wherein the first valve member opens to conduct the fuel gas to the environment through the filter room when the fuel gas pressure is higher than the pressure of the spring and closes to prevent fuel gas from flowing to the environment when the fuel gas pressure is lower than the pressure of the spring, and the second valve member opens to conduct the outside air to the fuel tank though the filter room when the fuel gas pressure is lower than the atmospheric pressure and closes to prevent the outside air from enter into the fuel tank when the fuel gas pressure is higher than the atmospheric pressure

2. The fuel volatilizing control system of claim 1, further comprising:
a first gas route communicated with the outlet and the fuel gas entrance, arranged in the closure body or in the fuel cover or between the closure body and the fuel cover;
at least one air hole communicated with the environment, arranged on the closure body or in the fuel cover or between the closure body and the fuel cover;
a second gas route communicated with the inlet and the air hole, arranged in the closure body, in the fuel cover or between the closure body and the fuel cover.

3. The fuel volatilizing control system of claim 1, wherein the filtering material is activated carbon.

4. The fuel volatilizing control system of claim 1, wherein the double-lane valve further comprising:
a valve room formed between the outlet and the inlet, wherein the first valve member is slidably arranged in the valve room, and a fuel gas channel is formed between the first valve member and the sidewall of the valve room;
a ring protrusion member formed on the first valve member, wherein a ring valve opening is formed between the inlet and the ring protrusion member to connect to the fuel gas channel; and
at least one air hole in the first valve member, covered by the second valve member.

5. The fuel volatilizing control system of claim 4, wherein the second valve member is a discal film.

6. The fuel volatilizing control system of claim 1, wherein the second valve member is a discal film.
